(19) United States
(12) Patent Application Publication
(10) Pub. No.: US 2020/0230998 A1
(43) Pub. Date: Jul. 23, 2020

(54) COMBINATION WRITING INSTRUMENT AND ACCESSORIES

(71) Applicant: Tina EDEKAR, Potomac, MD (US)

(72) Inventor: Tina EDEKAR, Potomac, MD (US)

(21) Appl. No.: 16/391,382

(22) Filed: Apr. 23, 2019

Related U.S. Application Data
(60) Provisional application No. 62/795,604, filed on Jan. 23, 2019.

(51) Int. Cl. B43K 27/08; B43K 29/00

(52) U.S. Cl. CPC B43K 27/08; B43K 29/004

(57) ABSTRACT

A multi-function pen and accessory devices and kits; specifically, writing instruments with a plurality of attachable and multi-functional personal care accessories and the like and kits. An accessory assembly may have a connector having a first connector end and a second connector end; a first accessory component configured to releasably mount to the first connector end; and a second accessory component configured to releasably mount to the second connector end.

### FIELD

Presented herein are writing instruments with attachable accessories, and in particular, writing instruments with a plurality of attachable and multi-functional personal care accessories and the like and kits.

### BACKGROUND

Various writing instruments such as pencils, pens, markers and the like are known in the art to mark various writing surfaces. Passive and active stylus devices are also known to be used as input devices on paperless or other non-writing surface mediums, such as a touch-sensitive panel on an electronic device (e.g., touch sensitive screens on smart phones). The frequency of use of such pens and styli, especially in business, usually means that such devices are carried by users throughout their day.

Also known in the art are various other types of handheld non-writing accessories, which are also frequently carried by people that may not have a specific business application such as lip stick, mascara applicators, pill carriers, and the like. These personal care accessories are often carried as separate items, which may be unwieldy, especially if it is not convenient to carry an accessory bag or purse into meetings and the like.

Combination pens are known to include, for example, multiple pens, pen/pencil combinations, pencil/eraser combinations, laser/stylus combinations, and other accessories to compliment the writing instrument or a business function. However, writing instruments combined with unrelated personal care items or provided as a kit with multiple accessory items is unknown.

### SUMMARY

Accordingly, to advance at least the aforementioned deficiencies in the art, described herein are multi-function pen and accessory devices and kits; specifically, writing instruments with a plurality of attachable and multi-functional personal care accessories and the like and kits.

According to one approach, a writing instrument assembly is shown having a barrel having disposed therein a writing instrument having a retracted position and an extended position; an accessory component; and a connector assembly to releasably mount the barrel to the accessory component.

The writing instrument may be selected from the group of a ball point ink cartridge, a passive stylus, and a graphite pencil, and the like and combinations thereof. The accessory component may be selected from a vibrator/massager, a laser, a flashlight, a mace/spray/perfume/aerosol, a projector, a GPS (mps battery), a key holder, a key holder ring, a key/key fob/rfid chip, a siren/alarm, a cell/fit bit/recorder/clock/gps, a e-cigarette, a pencil, a pill holder, a tire gauge, a glucose monitor, a breathalyzer, a mascara applicator and a lipstick applicator and the like and combinations thereof.

According to another approach, an accessory assembly may have a connector having a first connector end and a second connector end; a first accessory component configured to releasably mount to the first connector end; and a second accessory component configured to releasably mount to the second connector end.

The accessory component may be a vibrator/messager, a laser, a flashlight, a mace/spray/perfume/aerosol, a projector, a GPS (mps battery), a key holder, a key holder ring, a key/key fob/rfid chip, a siren/alarm, a cell/fit bit/recorder/clock/gps, a e-cigarette, a pencil, a pill holder, a tire gauge, a glucose monitor, a breathalyzer, a mascara applicator and a lipstick applicator.

According to one approach, A writing instrument assembly may have a barrel having disposed therein a writing instrument having a retracted position and an extended position;

an accessory component; a connector assembly to releasably mount the barrel to the accessory component; wherein the writing instrument is selected from the group consisting of a ball point ink cartridge, a passive stylus, and a graphite pencil; wherein the accessory component is selected from the group consisting of a vibrator, a laser, a flashlight, a mace/spray/perfume/aerosol, a projector, a GPS (mps battery), a key holder, a key holder ring, a key/key fob/rfid chip, a siren/alarm, a cell/fit bit/recorder/clock/gps, a e-cigarette, a pencil, a pill holder, a tire gauge, a glucose monitor, a breathalyzer, a mascara applicator and a lipstick applicator; wherein the connector assembly comprises a first connector assembly component integral or attachable to the barrel having an internal columnar extension, the internal columnar extension having a top end surface and at least one pin extending outwardly from the internal columnar extension; the connector assembly further comprising a second connector assembly component integral or attachable to the accessory component having a bore to receive the internal columnar extension, the bore having at least one slot matched to receive the at least one pin, the at least one slot extending inward from a bore opening to a first segment terminus, the slot angling off from the first segment terminus back towards an opening of the bore to an internal slot end; the second connector assembly component further having a plate configured to engage the top end surface of the internal extension; and a compressible component connected to the plate configured to provide a resistive force to the top end surface of the internal extension prior to the at least one pin reaching the slot first segment terminus, which is overcome by a user with 2-10 pounds of pressure until the slot first segment terminus is reached and is rotated and released at the internal slot end, wherein the compressive component holds the at least one pin in against the internal slot end.

According to this approach, there may be two pins and two slots and the compressible component can be compression spring or a rubber block.

Other features will become more apparent to persons having ordinary skill in the art to which the assemblies pertain and from the following description and claims.

### BRIEF DESCRIPTION OF THE DRAWINGS

FIG. 1 illustrates an exploded perspective view of one of present embodiments.

FIG. 2 illustrates a partial exploded perspective view of the embodiment of FIG. 1.

FIG. 3 illustrates perspective view of and assembled embodiment of FIG. 1.

FIG. 4 illustrates a close-up perspective view of area IV in FIG. 1 of a connector assembly.

FIG. 5 illustrates a partial exploded perspective view of another embodiment showing a connector assembly according to another approach.

FIG. 6 illustrates a partial exploded perspective view of a close-up of another embodiment showing a connector assembly according to yet another approach.

FIG. 7A illustrates a partial exploded perspective view of a close-up of another embodiment showing a connector assembly according to yet another approach.

FIG. 7B illustrates a partial perspective view of a close-up of the embodiment of 7A showing the connector assembly as it is being assembled.

FIG. 7C illustrates a partial perspective view of a close-up of the embodiment of 7B showing the assembled connector assembly.

FIG. 8 illustrates a perspective view of a kit having a plurality of components of the present embodiments.

FIGS. 9A and 9B illustrate cutaway planar views of an exploded close-up of another embodiment showing a connector assembly according to yet another approach.

FIGS. 10A, 10B, 100, 10D, 10E, 10F, 10G, 10H, 10I, 10J, 10K, 10L, 10M, 10N, 100, 10P, 10Q AND 10R illustrate perspective views of exemplary accessories of one of present embodiments.

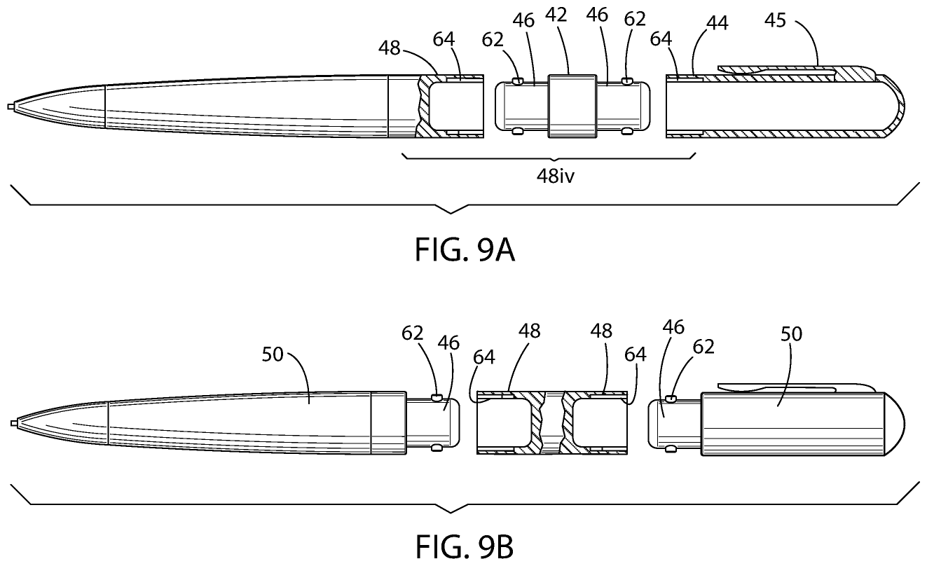

FIG. 9A-9B illustrates a cutaway planar view of an exploded close-up of another embodiment showing a connector assembly according to yet another approach.

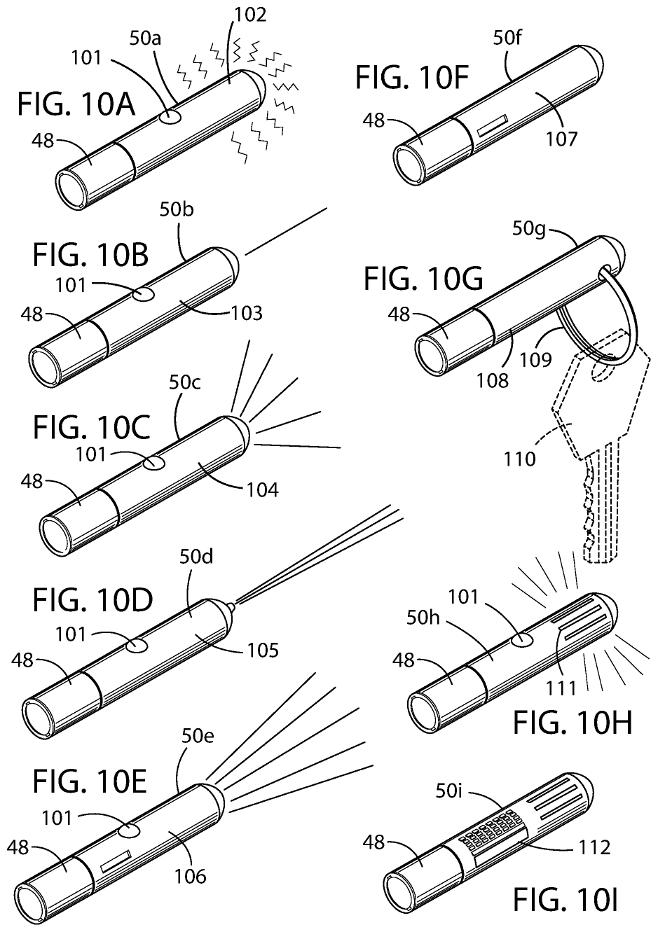

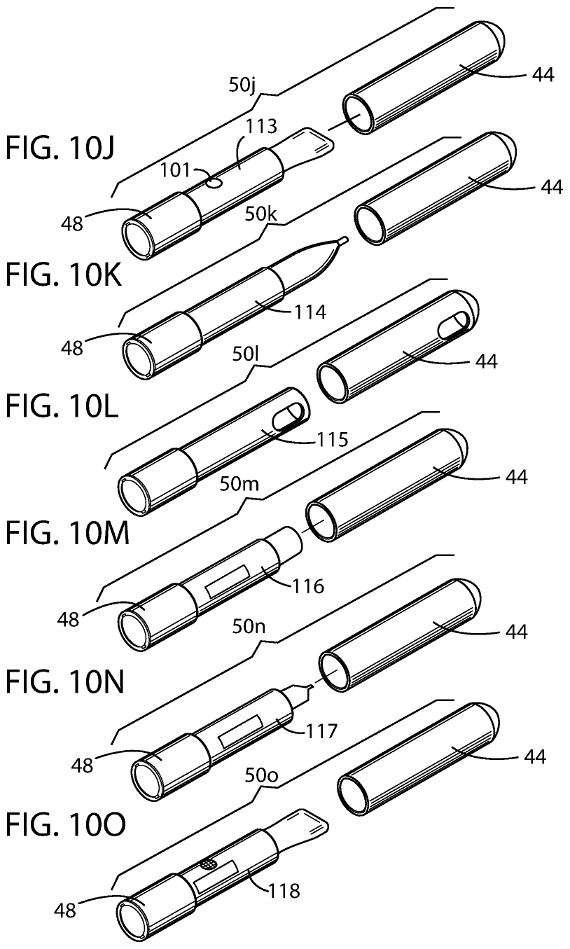

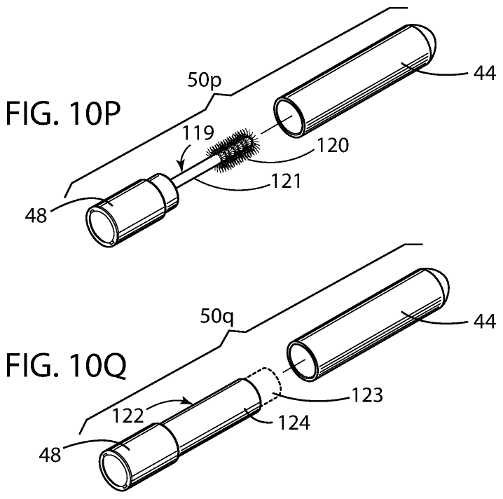

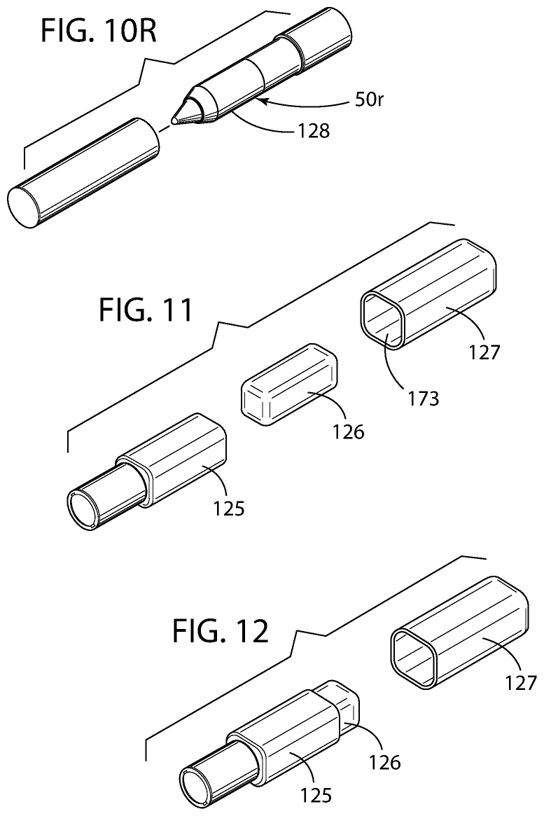

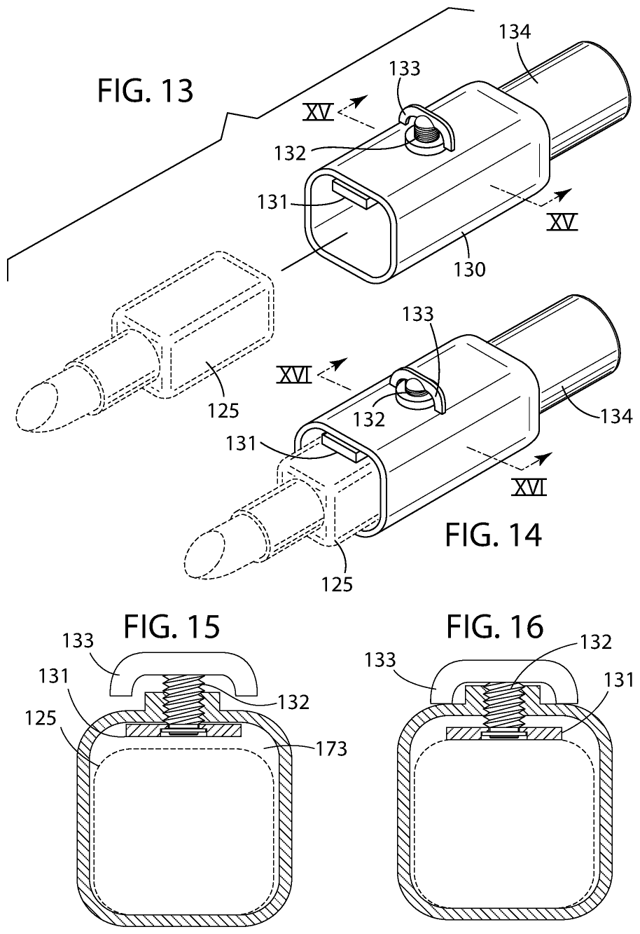

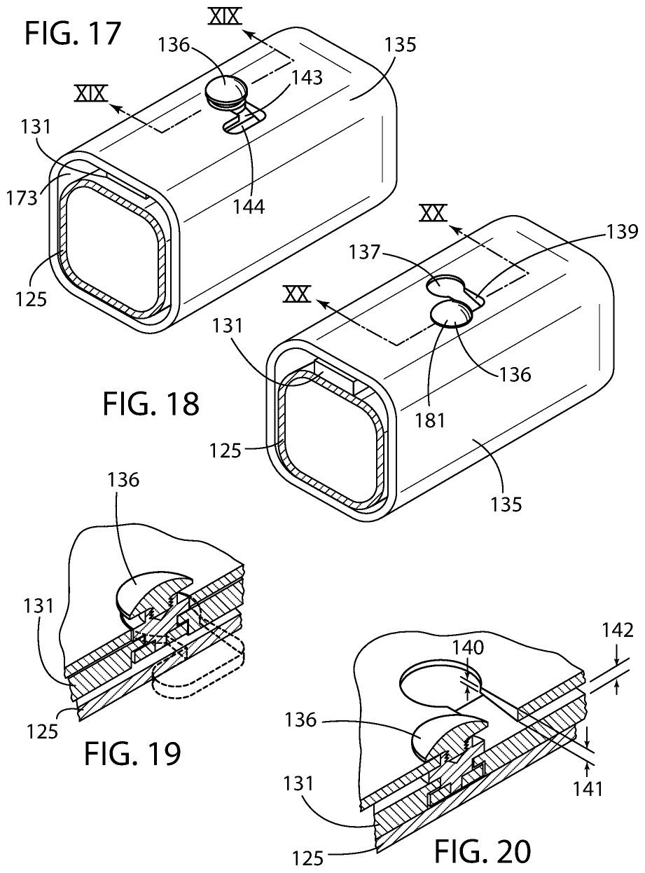

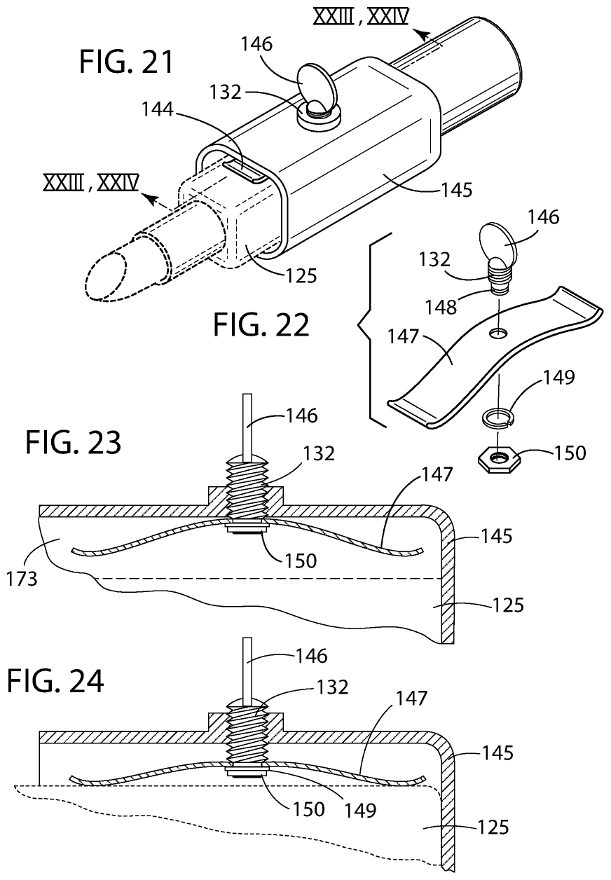

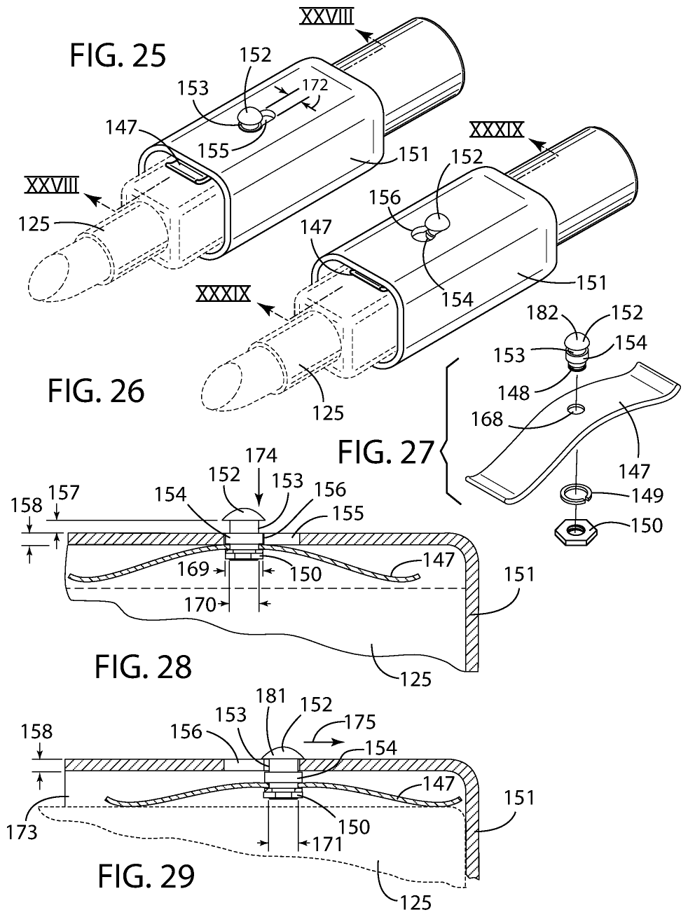

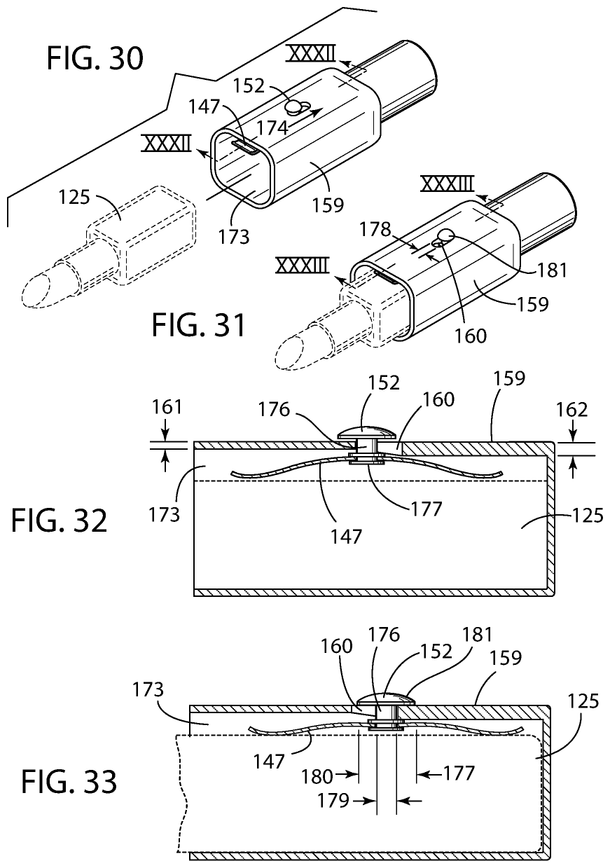

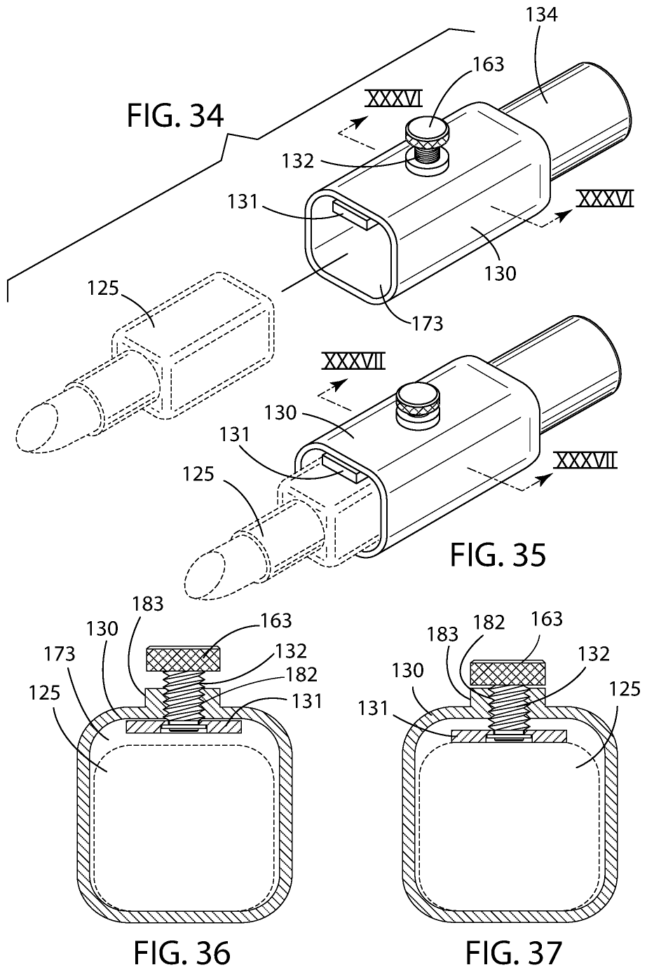

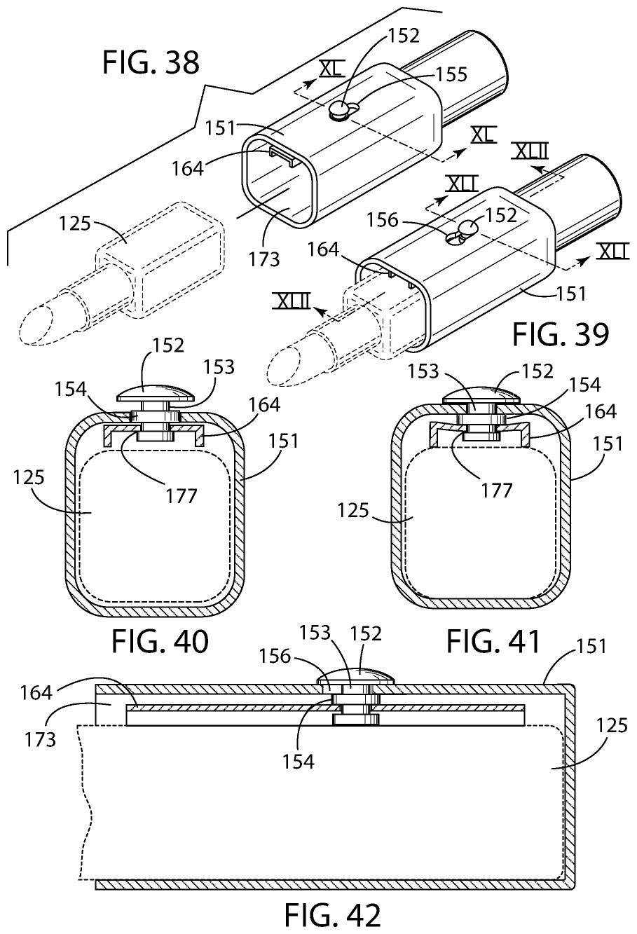

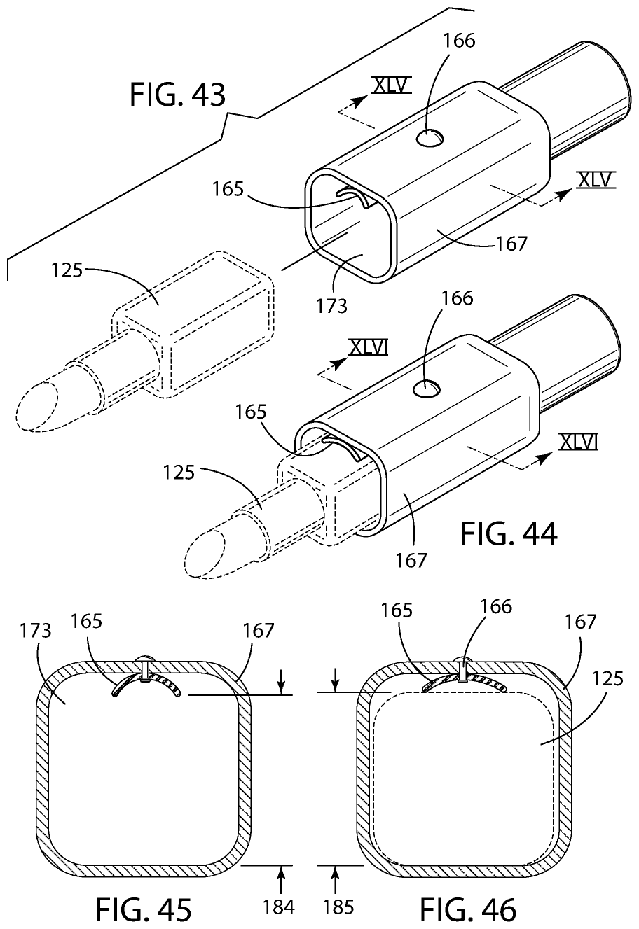

FIG. 10A-10R illustrates perspective views of exemplary accessories of one of present embodiments.

FIG. 11 illustrates an exploded perspective view of an accessory connector of the present embodiments.

FIG. 12 illustrates an exploded perspective view of another accessory connector of the present embodiments.

FIG. 13 illustrates an exploded perspective view of another accessory connector of the present embodiments in an open position.

FIG. 14 illustrates an assembled perspective view of the accessory connector of FIG. 13 in a clamped position.

FIG. 15 illustrates a cross-sectional side view taken along section lines XV-XV of FIG. 13.

FIG. 16 illustrates a cross-sectional side view taken along section lines XVI-XVI of FIG. 13.

FIG. 17 illustrates a perspective view of another accessory connector of the present embodiments in an open position.

FIG. 18 illustrates an assembled perspective view of the accessory connector of FIG. 17 in a clamped position.

FIG. 19 illustrates a cross-sectional perspective view taken along section lines XIX-XIX of FIG. 17.

FIG. 20 illustrates a cross-sectional perspective view taken along section lines XX-XX of FIG. 18.

FIG. 21 illustrates a perspective view of another accessory connector of the present embodiments.

FIG. 22 illustrates an exploded view of the clamping assembly of FIG. 21.

FIG. 23 illustrates a cross-sectional side view taken along section lines XXIII-XXIII of FIG. 21 in an open position.

FIG. 24 illustrates a cross-sectional side view taken along section lines XXIV-XXIV of FIG. 21 in a clamped position.

FIG. 25 illustrates a perspective view of another accessory connector of the present embodiments in an open position.

FIG. 26 illustrates an assembled perspective view of the accessory connector of FIG. 25 in a clamped position.

FIG. 27 illustrates an exploded view of the clamping assembly of FIG. 25.

FIG. 28 illustrates a partial cross-sectional side view taken along section lines XXVIII-XXVIII of FIG. 25.

FIG. 29 illustrates a partial cross-sectional side view taken along section lines XXXIX-XXXIX of FIG. 26.

FIG. 30 illustrates a perspective view of another accessory connector of the present embodiments in an open position.

FIG. 31 illustrates an assembled perspective view of the accessory connector of FIG. 30 in a clamped position.

FIG. 32 illustrates a cross-sectional side view taken along section lines XXXII-XXXII of FIG. 30.

FIG. 33 illustrates a cross-sectional side view taken along section lines XXXIII-XXXIII of FIG. 31.

FIG. 34 illustrates a perspective view of another accessory connector of the present embodiments in an open position.

FIG. 35 illustrates an assembled perspective view of the accessory connector of FIG. 34 in a clamped position.

FIG. 36 illustrates a cross-sectional end view taken along section lines XXXVI-XXXVI of FIG. 34.

FIG. 37 illustrates a cross-sectional end view taken along section lines XXXVII-XXXVII of FIG. 35.

FIG. 38 illustrates a perspective view of another accessory connector of the present embodiments in an open position.

FIG. 39 illustrates an assembled perspective view of the accessory connector of FIG. 34 in a clamped position.

FIG. 40 illustrates a cross-sectional end view taken along section lines XL-XL of FIG. 38.

FIG. 41 illustrates a cross-sectional end view taken along section lines XLI-XLI of FIG. 39.

FIG. 42 illustrates a cross-sectional side view taken along section lines XLII-XLII of FIG. 39.

FIG. 43 illustrates an exploded perspective view of another accessory connector of the present embodiments in an open position.

FIG. 44 illustrates an assembled perspective view of the accessory connector of FIG. 43 in a clamped position.

FIG. 45 illustrates a cross-sectional end view taken along section lines XLV-XLV of FIG. 43.

FIG. 46 illustrates a cross-sectional end view taken along section lines XLVI-XLVI of FIG. 44.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Presented herein are writing instruments with attachable accessories, and in particular, writing instruments with a plurality of attachable and multi-functional personal care accessories and the like and kits.

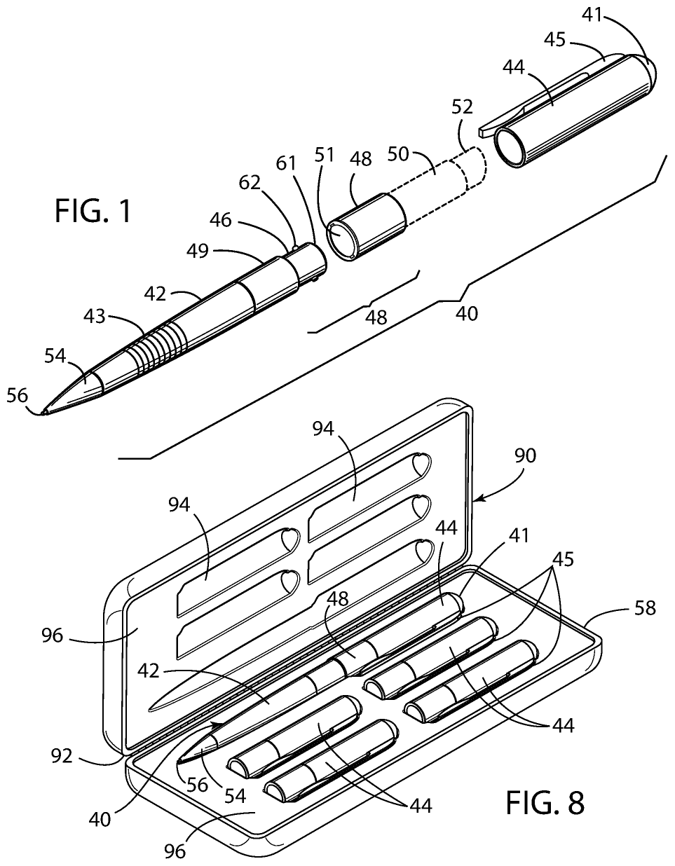

The present embodiments allow a user to carry at least two items that can be used in the course of a day and in kit form, the user is allowed the opportunity to carry a plurality of items in a kit form which can be, for example, contained within a container the size and shape of a case for sunglasses. According to one approach, a user is able to select from a variety of accessories all having common connections to allow interchangeability and to hold two accessories together. By way of example, a user may wish to have pen connected to a lipstick accessory. A common connector and the accessories may be designed to appear as a normal pen, such as shown in FIG. 1. In other embodiments, for economy of production and ease of use, the connectors may have visible fasteners. The connector may be attached to a core accessory, such as a pen and the accessories attachable thereon with a built-in reciprocal connector attachment. According to another approach, the connector can be a separate element which allows attachment on two sides to any of a plurality of accessories if a writing instrument is only to be an optional function. Through the specification, different connector configurations and assemblies are provided. It is noted that all such connector configurations can be adapted to be built onto an accessory or as a separate element allowing two accessory connections.

It is also noted that the current embodiments can be formed from plastics, polymers, rubber, milled wood or steel, cast metal, composites, 3D printed, compositions of synthetic and semi-synthetic organic compounds that are malleable and moldable into solid objects, and the like and combinations thereof.

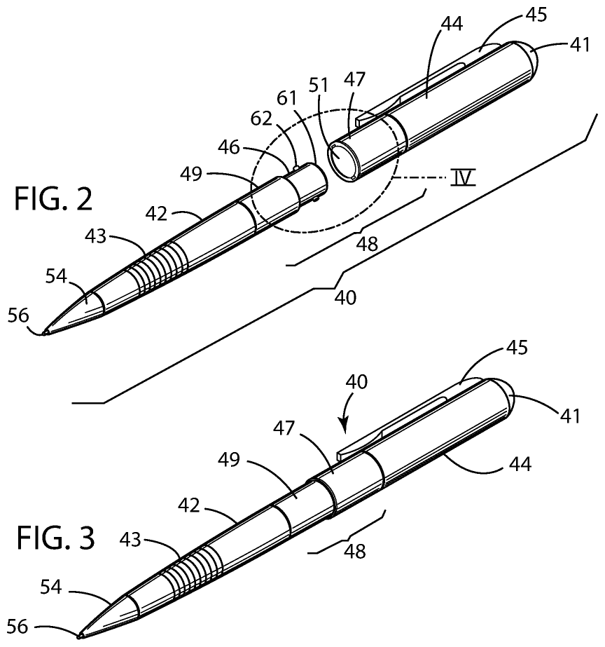

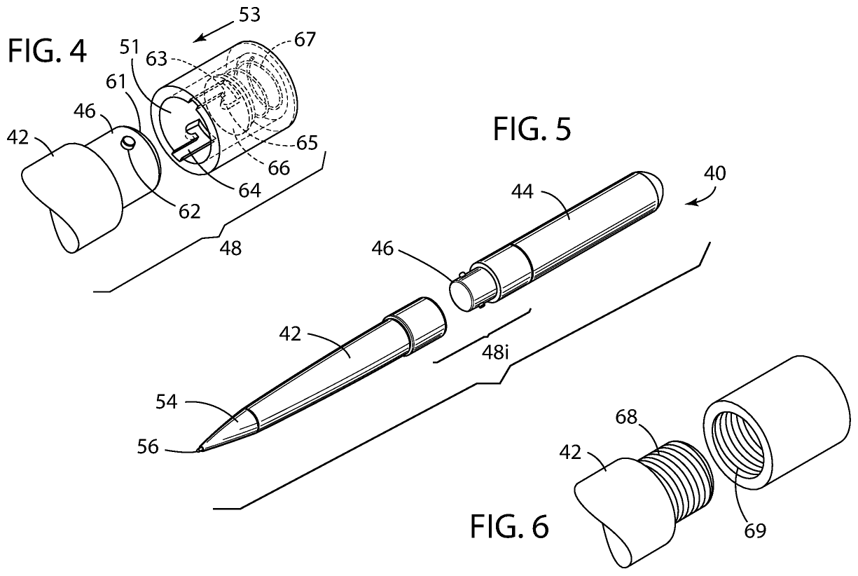

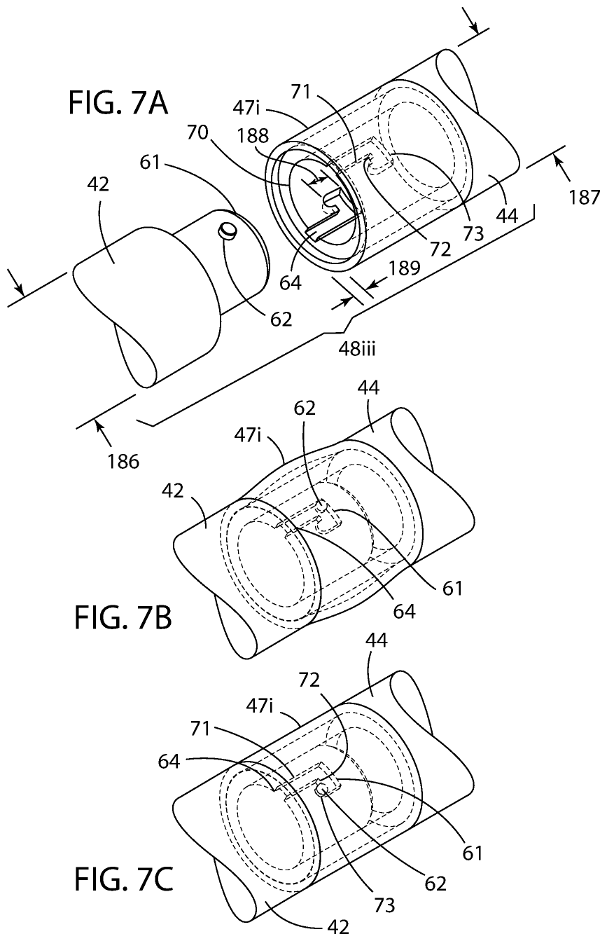

Turning now to the figures, FIG. 1 illustrates an exploded perspective view of one of present embodiments, showing a pen having a male connector and an exemplary accessory of a lipstick attachment. FIG. 2 illustrates a partial exploded perspective view of the embodiment of FIG. 1 and FIG. 3 illustrates perspective view of and assembled embodiment of FIG. 1. As shown in the figures, this pen/accessory combination shows a close up of a connector assembly according to one approach in FIG. 4 and another connector assembly in FIG. 6 according to another approach. FIG. 5 illustrates a partial exploded perspective view of another embodiment showing a connector assembly according to another approach where the male portion is on the accessory. FIG. 7 illustrates a partial exploded perspective view of a close-up of another embodiment showing a connector assembly according to yet another approach where instead of a spring, a rubber collar is used to hold the connector pins in place until the force is overcome by a use and twisted and slid to detach the accessories from one another.

Referring to FIGS. 1-3, an exemplary writing instrument 40 is shown that may have an optional eraser 41, a front/main barrel 42, an optional pen grip 43, pen tip 54, ball point/pencil point 56, a top housing/cap 44, and an optional clip 45. A connector assembly 48 may have an internal extension 46, an external collar 47; and a connector assembly mount 49 to front/main barrel 42. It is noted though that the connector may be mounted on either side or even not at all (see FIG. 9). The accessory 50 connected to the pen barrel 42 can include many items including many personal care items, such as the lipstick 52 as shown.

Connector assembly 48 can include a top surface 61 for internal extension 46 for pin(s) 62. As shown in FIG. 4, an arch 63 and slot 64 are configured to receive pin 62 up to terminal end 65 of slot 64. Plate 66 is configured to engage top surface 61 of internal extension for connector assembly 48 and progress into the connector bore 51 to receive extension 46 and pins 62. A compression spring 67 connected to plate 66 provides an outward resistive force 53, which is overcome by the user as it slides pins 62 up into slot 64 until it reaches the end of its travel. From there a user can rotate the pen barrel 42 until pins 62 reach its end of travel. From there a user can release the pen barrel 42 and pressure 53 from spring 67 will hold pin 62 up against terminal end 65. Force 53 is configured to provide enough force to hold the connection while during normal use, but to allow a user to overcome the force (e.g., about 2-10 pounds of pressure).

Another connector assembly is shown in FIG. 6 and shows an exemplary external thread 68 and an internal thread 69 matching external thread 68.

Another connector assembly is shown in FIG. 7 and shows where instead of a spring assembly (such as shown in FIG. 4), a rubber collar 47i is used to hold the connector pins in place until the force is overcome by a use and twisted and slid to detach the accessories from one another. As shown in FIG. 7, a rubber collar 47i is disposed around a portion of the end of top housing/cap 44 and has a diameter dimension 187 to engage an end portion of barrel 42 having, e.g., a comparable diameter dimension 186. Exposed slot 64 receives pin 62 as a user slides barrel 42 into an accessory opening along slot 64. Barrel 42 engages collar 47i before the end of the length of travel 61 of slot 64 requiring the user to apply addition pressure/force (preferable in the range of about 2-10 pounds) to advance barrel 42 to the end of the travel 61 of slot 62. As this is accomplished, collar 47i elastically deforms as shown in FIG. 7b. A user can then rotate the barrel relative to the accessory until it reaches position 73, where the user can release the barrel to allow the rubber collar to return to its non-deformed shape (FIG. 7c) and allows pin 62 to be secured and retained behind position 72. To achieve this secured and non-deformed shape, dimension 189 and 188 should be comparable in length.

FIG. 8 illustrates a perspective view of a kit having a plurality of components of the present embodiments. As shown for exemplary purposes a kit may have a case 90 having a hinge 92; wells for kit components 94; and internal surfaces 96 to contain kit components. Hinge 92 may be connected to a spring known in the art to hold a case closed, or case 90 may have a latch (not shown).

FIG. 9a illustrates a cutaway planar view of an exploded close-up of another embodiment showing a connector assembly according to yet another approach. In this approach. Connector 48iv is a separate component that can allow attachment of any two accessories irrespective of their function. This allows a user to not be forced to always have one accessory. This embodiment allows any two accessories to be detachably paired and can be changed at any time. In the illustrated embodiment pins 62 are on connector 48iv, which are received by slots and spring assembly as shown in FIG. 4, on the accessories of either side of connector 48iv. It is noted though that also within the scope of the present embodiments, extension 46 and pins 62 can be configured for placement on the accessory and collar having slides 62 can be configured on the connector, such as shown in FIG. 9a as connector assembly 48v.

FIG. 10a-10r illustrates perspective views of exemplary accessories 50a-50r for use with the present embodiments kits and at least any of the connector assemblies described herein. For example, such accessories may include, a vibrator/massager 102 having an/off switch 101 (FIG. 10a); a laser 103 (FIG. 10b); a flashlight 104 (FIG. 10c); mace/spray/perfume/aerosol dispenser 105 (FIG. 10d); a projector 106 (FIG. 10e); a GPS, tracker, or monolithic power system (mps battery) 107; (FIG. 100; a key holder 108; a key holder ring 109 a key/key fob/rfid chip 110 (FIG. 10g); a siren/alarm 111 (FIG. 10h); a cellular phone/fitness tracker/digital recorder/clock with display/gps with display 112 (FIG. 10i); an e-cigarette 113 (FIG. 10j); a pencil 114 (FIG. 10k); a pill holder 115 (FIG. 10l); a tire gauge 116 (FIG. 10m); a glucose monitor 117 (FIG. 10n); a breathalyzer 118 (FIG. 10o); a mascara applicator 119 having a mascara applicator stem 120 and a mascara applicator brush 121 (FIG. 10p); a lipstick applicator 122 having a lipstick applicator lipstick 123 and a lipstick applicator stem 124 (FIG. 10q); and an eye liner 128 having an eye liner pencil (FIG. 10r).

FIGS. 11 and 12 illustrates perspective views of an accessory connector of the present embodiments according to another approach. Here a square connector 126 can be used to connect accessories such as having a square lipstick 125 and the square barrel 127 of a second accessory. Square connector 125 can be formed from a deformable and compressible material such as a rubber or closed foam composition that can be releasable forced into an opening of the accessory having a small diameter or opening size than connector 125 (e.g., 1-3 mm smaller). Although the connector is shown as a square in this embodiment, it is understood that a round, triangle or any other polygon shape may be used. This understanding is also applied to all the connectors described herein.

FIGS. 13-16 illustrate views of a connector assembly of the present embodiment according to another approach. FIG. 13 shows the accessory connector 130 in an open position, and FIG. 14 illustrates the accessory connector 130 in a clamped position. As shown, square connector barrel 130 may have a gripping bar 131, a threaded rod 132 connected to gripping bar 131, a turn tab 133 all connected to, for example, a pen barrel 134. In this embodiment, an exemplary accessory 125 can be configured to slide into connector 130 when gripping bar is in its retracted position (See FIG. 15). Once the accessory has be installed with the opening of connector, the user can press gripping bar 131 onto the accessory to mount it to the connector by turning the treaded rod against in internal thread in the connector housing (not shown), which drives the gripping bar downward or upward. Gripping bar 131 can be formed from a compressible and deformable material such as a rubber, a composite or a closed foam and/or have an anti-skid surface facing the accessory to prevent it from sliding out of the connector.

FIGS. 17-20 illustrate views of a connector assembly of the present embodiment according to another approach. FIG. 17 shows the accessory connector 135 in an open position, and FIG. 18 illustrates the accessory connector 135 in a clamped position. As shown, square connector barrel 135 may have a gripping bar 131. As shown, square connector barrel 135 may have a thumb button slider 136, a thumb slider flange opening 137, thumb slider flange 138, a travel slide 139 to drive gripping bar against accessory, a thinnest travel slide dimension 140 (e.g., 1 mm), a thickest travel slide dimension 141 (e.g., 2-3 mm), amount of downward movement of gripper 131 forced to travel slide 142 (e.g., dimension 141-dimension 142), a travel opening 143 for thumb slide, and a locking travel 144 for thumb slide. In this embodiment, an exemplary accessory 125 can also be configured to slide into connector 135 when gripping bar is in its retracted position (See FIGS. 17 and 19). Once the accessory has be installed with the opening of connector, the user can slide thumb button slider 136 from its position in FIGS. 17 and 19 to its position in FIGS. 18 and 20, thus pressing gripping bar 131 onto the accessory to mount it to the connector. The change in position is caused by the ramp effect of the change of thickness caused by slide 139.

FIGS. 21-24 illustrate views of a connector assembly of the present embodiment according to another approach. FIG. 23 shows the accessory connector 145 in an open position, and FIG. 24 illustrates the accessory connector 145 in a clamped position. As shown, square connector barrel 145 may have a turn tab 146; a flexible spring bar 147; a threaded portion 148 to attach nut 150; a lock washer 149 and a nut 150. Threaded rod 132 can be used to raise and retract flexible spring bar 147. In this embodiment, an exemplary accessory 125 can be configured to slide into connector 145 when flexible spring bar 147 is in its retracted position (See FIG. 23). Once the accessory has be installed within the opening of connector, the user can press flexible spring bar 147 onto the accessory to mount it to the connector by turning the treaded rod against in internal thread in the connector housing (not shown), which drives the flexible spring bar 147 downward or upward. Flexible spring bar 147 can be formed from a deformable material such as a rigid plastic, a composite, spring steel and the like.

FIGS. 25-29 illustrate views of a connector assembly of the present embodiment according to another approach. FIGS. 25 and 27 show an accessory connector 151 in an open position, and FIGS. 26 and 29 illustrate the accessory connector 151 in a closed/clamped position. As shown, a flexible spring bar 147 is slideably attached to square connector barrel 151 by a thumb slide 152 having a thumb slide stem 153 and a thumb slide flange 154, a threaded portion 148 to attach nut 150; a lock washer 149 and a nut 150. The attachment to square connector barrel 151 is by the stem 153 extending through an opening 168 of flexible spring bar 147 to receive thumb slide stem 153. Again, flexible spring bar 147 can be formed from a deformable material such as a rigid plastic, a composite, spring steel and the like. Accessory connector 151 has a thumb slide narrow opening 155 to receive thumb slide stem 154 and a thumb slide round opening 156 to receive thumb slide flange 154. Thumb slide round opening dimension 169 is larger than thumb slide flange 154 diameter dimension 170 by, e.g., 0.5 mm to 1 mm. Thumb slide narrow opening dimension 172 (FIG. 25) is greater than thumb slide stem diameter dimension 171 (FIG. 28) by, e.g., 0.5 mm to 1 mm. In this approach, barrel thickness dimension 158 can be approximately equal to stem height dimension 157.

In use, flange 154 is disposed within flange opening 156 in the open position and is configured to allow an accessory 125 to slide into an accessory connector cavity 173. Once an accessory is installed, a user can clamp the accessory by pushing down thumb slide 152 in direction 174 until thumb slide 152 touches connector 151 then sliding thumb slide in direction 175 to the end of travel in slide portion 155. The difference in dimensions 157, 158 and stiffness of spring bar 147 are configured to hold the accessory during use in a clamped position while allowing a user to slide the thumb slide 152 to release the accessory. It is noted that although the flange and flange opening are circular in this embodiment, it is understood that a square, round, triangle or any other polygon shapes may be used. This understanding is also applied to all slide assemblies described herein.

FIGS. 30-33 illustrate views of a connector assembly of the present embodiment according to another thumb slide approach. FIGS. 30 and 32 show an accessory connector 159 in an open position, and FIGS. 31 and 33 illustrate the accessory connector 159 in a closed/clamped position. As shown, a flexible spring bar 147 is slideably attached to square connector barrel 159 by thumb slide 152 having a thumb slide stem 176 and a thumb slide rivet 177 to attached flange stem 176 to flexible spring bar 147. Again, flexible spring bar 147 can be formed from a deformable material such as a rigid plastic, a composite, spring steel and the like and can also use the same attachment with a nut, treaded rod, etc as shown in previous embodiments. Also, noted that the previous embodiments may also use a rivet to attach a slide stem to a gripping bar or spring bar. Accessory connector 159, as shown, has a thumb slide travel opening 160 with tapered thickness. For example, thin barrel end thickness 161 can have a dimension that is 1 mm to 3 mm thinner than thick barrel end thickness 162. The difference dimensions 162 and 161 is shown by travel opening 160 tapered thickness. Travel opening 160 and have a width 178 that is slightly larger than stem 176 diameter 179 by, e.g., 0.5 mm to 1 mm, but is narrower than a thumb slide 152 cap 181 (which would be the case for all embodiments having a slide opening and stem extending therethrough).

In use, stem 176 is disposed within travel opening 160 in the open position as shown in FIGS. 13 and 32 and is configured to allow an accessory 125 to slide into an accessory connector cavity 173. Once an accessory is installed, a user can clamp the accessory by sliding thumb slide 152 in direction 174 (FIG. 30) to the end of travel in slide portion 160 as shown in FIGS. 31 and 33. Again, the difference in dimensions 161, 162 and stiffness of spring bar 147 are configured to hold the accessory during use in a clamped position while allowing a user to slide the thumb slide 152 to release the accessory.

FIGS. 35-37 illustrate views of a connector assembly of the present embodiment according to another approach similar that of FIGS. 13-16. FIGS. 34 and 36 show accessory connector 130 in an open position, and FIGS. 35 and 37 illustrate the accessory connector 130 in a clamped position. As shown, square connector barrel 130 may have a gripping bar 131, a threaded rod 132 connected to gripping bar 131, a knurled knob 163 all connected to, for example, a pen barrel 134. In this embodiment, an exemplary accessory 125 can be configured to slide into connector 130 when gripping bar is in its retracted position (See FIG. 34). Once the accessory has be installed with the opening of connector, the user can press gripping bar 131 onto the accessory to mount it to the connector by turning the treaded rod against in internal thread 182 in a connector housing (not shown), which drives the gripping bar downward or upward. Gripping bar 131 can be formed from a compressible and deformable material such as a rubber, a composite or a closed foam and/or have an anti-skid surface facing the accessory to prevent it from sliding out of the connector.

FIGS. 38-42 illustrate views of a connector assembly of the present embodiment according to another approach similar to that of FIGS. 25-29. FIGS. 38 and 40 show an accessory connector 151 in an open position, and FIGS. 39, 41 and 42 illustrate the accessory connector 151 in a closed/clamped position. As shown, a gripping channel bar 164 held to stem 153 by a rivet 177 and is slideably attached to square connector barrel 151 by a thumb slide 152 having a thumb slide stem 153 in an arrangement equivalent to the arrangement in FIGS. 25-29. Channel bar 164 can be formed from a deformable and compressible material such as a rubber or closed foam composition.

FIGS. 43-46 illustrate views of a connector assembly 167 of the present embodiments according to another approach. FIGS. 43 and 45 show an accessory connector 167 without an accessory 125 installed, while FIGS. 44 and 46 illustrate accessory connector 167 clamping an accessory 125. As shown, a gripping arched bar 165 is held to connector 167 by a rivet 166. In use, a user pushes the accessory into cavity 173, deforming arched bar 165 since dimension 184 is smaller than accessory 125 dimension 185 by, e.g., 1 mm to 3 mm. The dimension are configured to allow a user/pull to push the accessory into/out of the channel with a pressure of less than 2-10 pounds, while allowing the accessory to remain fastened to connector 167 while in use. Arched bar 165 can be formed from a deformable and compressible material such as a rubber or a closed foam composition with a non-skid surface.

The drawings and the foregoing descriptions are not intended to represent the only forms of the kits and accessory assemblies in regard to the details of construction. Changes in form and in proportion of parts, as well as the substitution of equivalents, are contemplated as circumstances may suggest or render expedient.

While the embodiments have been described in conjunction with specific embodiments, it is evident that many alternatives, modifications and variations will be apparent to those skilled in the art in light of the foregoing description. Accordingly, the present embodiments attempt to embrace all such alternatives, modifications and variations that fall within the spirit and scope of the appended claims. Throughout this specification and the drawings and figures associated with this specification, numerical labels of previously shown or discussed features may be reused in another drawing figure to indicate similar features.

### LIST OF REFERENCE NUMBERS

40 writing instrument
41 optional eraser
42 front/main barrel
43 optional pen grip
44 top housing/cap
45 optional clip
46 internal extension for connector assembly 48
47 external collar for connector assembly 48
48 connector assembly
49 connector assembly mount to front/main barrel 42
50 accessory (multiple applications)
51 connector bore to receive extension 46
52 lipstick
53 outward force
54 tip
56 ball point/pencil point
61 top surface for internal extension for connector assembly 48
62 pin
63 arch on slot 64
64 slot to receive pin 62
65 terminal end of slot 64
66 plate to engage top surface 61 of internal extension for connector assembly 48
67 compression spring connected to plate 66
68 external thread
69 internal thread matching external thread 68
90 case for kit
92 hinge
94 wells for kit components
96 internal surface to contain kit components
101 on/off switch
102 vibrator
103 laser
104 flashlight
105 mace/spray/perfume/aerosol
106 projector
107 GPS (mps battery)
108 key holder
109 key holder ring
110 key/key fob/rfid chip
111 siren/alarm
112 cell/fit bit/recorder/clock/gps
113 e-cigarette
114 pencil
115 pill holder
116 tire gauge
117 glucose monitor
118 breathalyzer
119 mascara applicator
120 mascara applicator stem
121 mascara applicator brush
122 lipstick applicator
123 lipstick applicator lipstick
124 lipstick applicator stem
125 square lipstick
126 square connector
127 square barrel
128 eye liner
130 square connector barrel
131 gripping bar
132 threaded rod connected to gripping bar 131
133 turn tab
134 pen barrel
135 alternate square connector barrel
136 thumb button slider
137 thumb slider flange opening
138 thumb slider flange
139 travel slide to drive gripping bar against accessory
140 thinnest travel slide dimension (e.g., 1 mm)
141 thickest travel slide dimension (e.g., 2-3 mm)
142 amount of movement forced to travel slide (e.g., dimension 141-dimension 142)
143 travel opening for thumb slide
144 locking travel for thumb slide
145 alternate square connector barrel
146 turn tab
147 flexible spring bar
148 threaded portion to attach nut 150
149 lock washer
150 nut
151 alternate square connector barrel
152 thumb slide
153 thumb slide stem
154 thumb slide flange
155 thumb slide narrow opening to receive thumb slide stem
156 thumb slide round opening to receive thumb slide flange 154
157 thumb slide stem height dimension
158 barrel thickness dimension approximately equal to stem height 157
159 alternate square connector barrel
160 thumb slide travel opening with tapered thickness
161 thin barrel end thickness
162 thick barrel end thickness
163 knurled knob
164 gripping channel bar
165 gripping arched bar
166 rivet to hold arched bar
167 alternate square connector barrel
168 opening of flexible spring bar 147 to receive thumb slide stem 153
169 thumb slide round opening dimension (larger than thumb slide flange by, e.g., 0.5 mm to 1 mm)
170 thumb slide flange 154 diameter dimension (smaller diameter than dimension 169 by, e.g., 0.5 mm to 1 mm)
171 thumb slide stem diameter dimension
172 thumb slide narrow opening dimension (larger than dimension 171 by, e.g., 0.5 mm to 1 mm)
173 accessory connector cavity
174 push direction
175 slide direction
176 stem (FIG. 30)
177 rivet
178 slide opening 160 dimension (e.g., 0.5 mm to 1 mm greater than dimension 179)
179 stem 176 diameter dimension (e.g., 2 mm-4 mm)
180 cap 181 diameter dimension (e.g., 5 mm-7 mm)
181 stem cap
182 internal threads
183 connector housing
184 dimension (FIG. 45)
185 dimension (FIG. 46)
186 dimension (FIG. 7)
187 dimension (FIG. 7)
188 dimension (FIG. 7)
189 dimension (FIG. 7)

I claim:

1. A writing instrument assembly, comprising:
a barrel having disposed therein a writing instrument having a retracted position and an extended position;
an accessory component; and
a connector assembly to releasably mount the barrel to the accessory component.

2. The writing instrument of claim 1, wherein the writing instrument is selected from the group consisting of a ball point ink cartridge, a passive stylus, and a graphite pencil.

3. The writing instrument of claim 1, wherein the accessory component is selected from the group consisting of a vibrator, a laser, a flashlight, a mace/spray/perfume/aerosol, a projector, a GPS (mps battery), a key holder, a key holder ring, a key/key fob/rfid chip, a siren/alarm, a cell/fit bit/recorder/clock/gps, a e-cigarette, a pencil, a pill holder, a tire gauge, a glucose monitor, a breathalyzer, a mascara applicator and a lipstick applicator.

4. An accessory assembly, comprising:
a connector having a first connector end and a second connector end;
a first accessory component configured to releasably mount to the first connector end; and
a second accessory component configured to releasably mount to the second connector end.

5. The accessory assembly of claim 4, wherein the accessory component is selected from the group consisting of a vibrator, a laser, a flashlight, a mace/spray/perfume/aerosol, a projector, a GPS (mps battery), a key holder, a key holder ring, a key/key fob/rfid chip, a siren/alarm, a cell/fit bit/recorder/clock/gps, a e-cigarette, a pencil, a pill holder, a tire gauge, a glucose monitor, a breathalyzer, a mascara applicator and a lipstick applicator.

6. A writing instrument assembly, comprising:
a barrel having disposed therein a writing instrument having a retracted position and an extended position;
an accessory component; and
a connector assembly to releasably mount the barrel to the accessory component.

7. A writing instrument assembly, comprising:
a barrel having disposed therein a writing instrument having a retracted position and an extended position;
an accessory component;
a connector assembly to releasably mount the barrel to the accessory component;
wherein the writing instrument is selected from the group consisting of a ball point ink cartridge, a passive stylus, and a graphite pencil;
wherein the accessory component is selected from the group consisting of a vibrator, a laser, a flashlight, a mace/spray/perfume/aerosol, a projector, a GPS (mps battery), a key holder, a key holder ring, a key/key fob/rfid chip, a siren/alarm, a cell/fit bit/recorder/clock/gps, a e-cigarette, a pencil, a pill holder, a tire gauge, a glucose monitor, a breathalyzer, a mascara applicator and a lipstick applicator;
wherein the connector assembly comprises a first connector assembly component integral or attachable to the barrel having an internal columnar extension, the internal columnar extension having a top end surface and at least one pin extending outwardly from the internal columnar extension;
the connector assembly further comprising a second connector assembly component integral or attachable to the accessory component having a bore to receive the internal columnar extension, the bore having at least one slot matched to receive the at least one pin, the at least one slot extending inward from a bore opening to a first segment terminus, the slot angling off from the first segment terminus back towards an opening of the bore to an internal slot end;
the second connector assembly component further having a plate configured to engage the top end surface of the internal extension; and
a compressible component connected to the plate configured to provide a resistive force to the top end surface of the internal extension prior to the at least one pin reaching the slot first segment terminus, which is overcome by a user with 2-10 pounds of pressure until the slot first segment terminus is reached and is rotated and released at the internal slot end, wherein the compressive component holds the at least one pin in against the internal slot end.

8. The writing instrument assembly of claim 7, wherein there are two pins and two slots.

9. The writing instrument assembly of claim 8, wherein the compressible component is a compression spring.

10. The writing instrument assembly of claim 8, wherein the compressible component is a rubber block.
